(19) United States
(12) Patent Application Publication
(10) Pub. No.: US 2022/0342491 A1
(43) Pub. Date: Oct. 27, 2022

(54) PROJECTOR AND METHOD FOR OPERATING PROJECTOR

(71) Applicant: Coretronic Corporation, Hsin-Chu (TW)

(72) Inventors: Hsiu-Min Hsiao, Hsin-Chu (TW); Chien-Wei Wang, Hsin-Chu (TW); Chih-Lin Wang, Hsin-Chu (TW)

(73) Assignee: Coretronic Corporation, Hsin-Chu (TW)

(21) Appl. No.: 17/702,810

(22) Filed: Mar. 24, 2022

(30) Foreign Application Priority Data
Apr. 26, 2021 (CN) 202110451005.6

(51) Int. Cl. G06F 3/0362; G06F 3/0482; G09G 5/00

(52) U.S. Cl. CPC G06F 3/0362; G06F 3/0482; G09G 5/003; G09G 2354/00; G09G 2320/08

(57) ABSTRACT

A projector including a controller circuit and a shuttle wheel, and an operating method are provided. The controller circuit controls an operation of the projector. The shuttle wheel is disposed on an upper cover of the projector. The controller circuit controls whether the projector enters an on screen display mode according to an operation method of the shuttle wheel. When the projector enters the on screen display mode, the controller circuit controls the projector to project a first menu on a screen. According to the operation method of the shuttle wheel, the controller circuit selects an adjustment item of the projector on the first menu. When the projector does not enter the on screen display mode, the controller circuit controls the projector to project a second menu on the screen. According to the operation method of the shuttle wheel, the controller circuit sets the adjustment item on the second menu.

### CROSS-REFERENCE TO RELATED APPLICATION

This application claims the priority benefit of China application serial no. 202110451005.6, filed on Apr. 26, 2021. The entirety of the above-mentioned patent application is hereby incorporated by reference herein and made a part of this specification.

### BACKGROUND

### Technical Field

The disclosure relates to a projector and a method for operating the projector, and in particular, to a projector with a shuttle wheel and a method for operating the projector.

### Description of Related Art

Generally, to adjust functions of the brightness, image mode, gamma setting, volume, and signal input source of a projector, the user needs to operate a keypad (for example, the keypad is disposed on a projector or a remote controller) to enter an on screen display mode for setting, which is inconvenient to use. Furthermore, when operating with the keypad, the user needs to look at the displayed image and set the functions at the same time. As a result, the user tends to operate with an error or fail to set the functions before the on screen display mode terminates the setting and exits.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure is directed to a projector with a shuttle wheel and a method for operating the projector, which allow a user to conveniently set the projector.

Other objectives and advantages of the disclosure will be further understood from the further technological features disclosed by the embodiments of the disclosure.

To achieve one of, a part of, or all of the objectives of the disclosure, an embodiment of the disclosure is directed to a projector including a controller circuit and a shuttle wheel. The controller circuit is configured to control an operation of the projector. The shuttle wheel is disposed on an upper cover of the projector and is coupled to the controller circuit. The controller circuit controls whether the projector enters an on screen display mode according to an operation method of the shuttle wheel. When the projector enters the on screen display mode, the controller circuit controls the projector to project a first menu on a screen. According to the operation method of the shuttle wheel, the controller circuit selects an adjustment item of the projector on the first menu. When the projector does not enter the on screen display mode, the controller circuit controls the projector to project a second menu on the screen. According to the operation method of the shuttle wheel, the controller circuit sets the adjustment item of the projector on the second menu.

To achieve one of, a part of, or all of the objectives of the disclosure, an embodiment of the disclosure is directed to a method for operating a projector. The projector includes a shuttle wheel. The method for operating the projector includes: controlling whether the projector enters an on screen display mode according to an operation method of the shuttle wheel; controlling the projector to project a first menu on a screen when the projector enters the on screen display mode, and selecting an adjustment item of the projector on the first menu according to the operation method of the shuttle wheel; and controlling the projector to project a second menu on the screen when the projector does not enter the on screen display mode, and setting the adjustment item of the projector on the second menu according to the operation method of the shuttle wheel.

In light of the above, the embodiment of the disclosure has at least one of the following advantages or features. The disclosure is directed to the projector with a shuttle wheel and the method for operating the projector, allowing a user to conveniently set the projector.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic perspective view of a projector and a screen according to an embodiment of the disclosure.

FIG. 2 is a schematic block diagram of the projector according to an embodiment of the disclosure.

FIG. 3 is a schematic view illustrating an operation method of a shuttle wheel according to the embodiment of FIG. 1 and FIG. 2.

FIG. 4 is a schematic view of the screen displaying a first menu according to an embodiment of the disclosure.

FIG. 5 is a schematic view of the screen displaying a second menu according to an embodiment of the disclosure.

FIG. 6 is a flow chart of the screen displaying the second menu according to an embodiment of the disclosure.

FIG. 7 is a schematic view of the shuttle wheel according to an embodiment of the disclosure.

FIG. 8 is a procedure flow chart of a method for operating the projector according to an embodiment of the disclosure.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

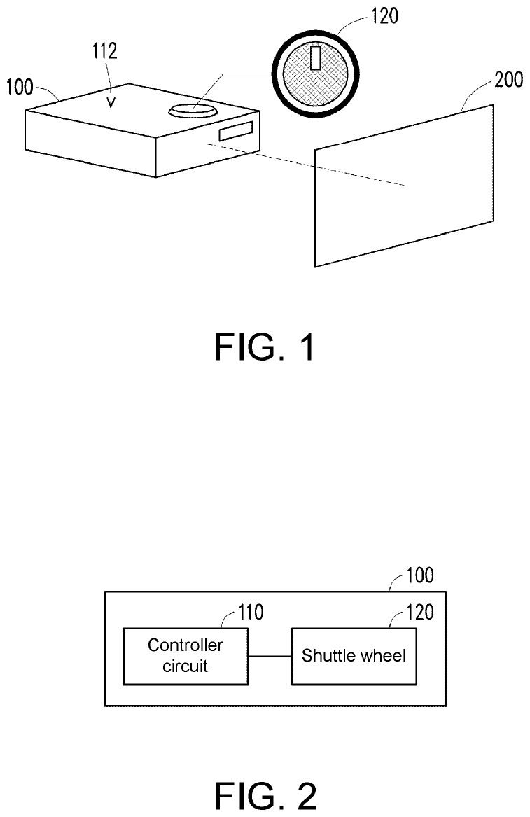

FIG. 1 is a schematic perspective view of a projector and a screen according to an embodiment of the disclosure. FIG. 2 is a schematic block diagram of the projector according to an embodiment of the disclosure. Referring to FIG. 1 and FIG. 2, a projector 100 is configured to project an image on a screen 200 in an image display mode, and project a shortcut menu (a first menu) on the screen 200 in an on screen display mode. The projector 100 includes a controller circuit 110 and a shuttle wheel 120. The controller circuit 110 is configured to control an operation of the projector 100. The shuttle wheel 120 is disposed on an upper cover 112 of the projector 100 and is coupled to the controller circuit 110. The controller circuit 110 controls whether the projector 100 enters the on screen display mode according to an operation method of the shuttle wheel. Note that the on screen display mode may be another operation mode of the projector 100, or the projector 100 may project the first menu to cover (completely cover or mostly cover) the image of the image display mode. Nevertheless, the disclosure is not limited thereto.

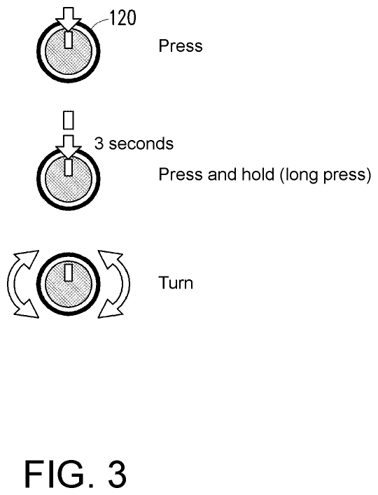

FIG. 3 is a schematic view illustrating an operation method of the shuttle wheel according to the embodiment of FIG. 1 and FIG. 2. Referring to FIG. 3, the operation method of the shuttle wheel 120 at least includes pressing, pressing and holding (i.e., long pressing), and turning. Long pressing is, for example, that the user presses the shuttle wheel 120 and holds for a period of time, for example, 3 seconds. The period of time is not intended to limit the disclosure. Turning includes turning to the left and turning to the right.

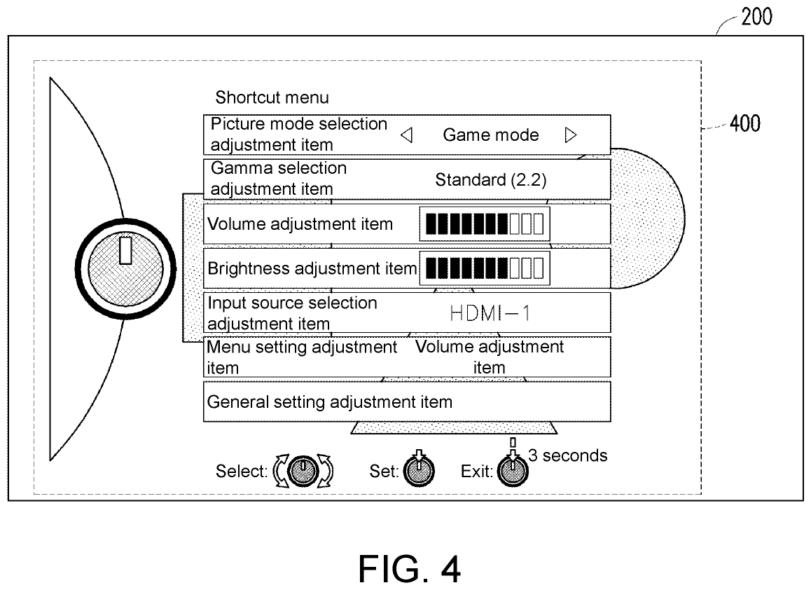

FIG. 4 is a schematic view of the screen displaying a first menu according to an embodiment of the disclosure. Referring to FIG. 1 and FIG. 4, when the shuttle wheel 120 is pressed, the projector 100 enters the on screen display mode, and the controller circuit 110 controls the projector 100 to project a first menu 400 on the screen 200. The first menu 400 includes multiple adjustment items of the projector 100. According to the operation method of the shuttle wheel 120, the user (and/or the controller circuit 110) may select and set the adjustment items of the projector 100 on the first menu 400. The adjustment items of the projector 100 include a picture mode selection adjustment item, a gamma selection adjustment item, a volume adjustment item, a brightness adjustment item, an input source selection adjustment item, a menu setting adjustment item and a general setting adjustment item. For example, after entering the on screen display mode, the user may turn the shuttle wheel 120 to select the adjustment items of the projector 100. Next, the user may press the shuttle wheel 120 to set a selected adjustment item of the projector 100. In addition, the user may also long press the shuttle wheel 120 to exit the currently selected adjustment item of the projector 100 or exit the first menu 400 to return to the state where the first menu 400 is not displayed on the screen 200.

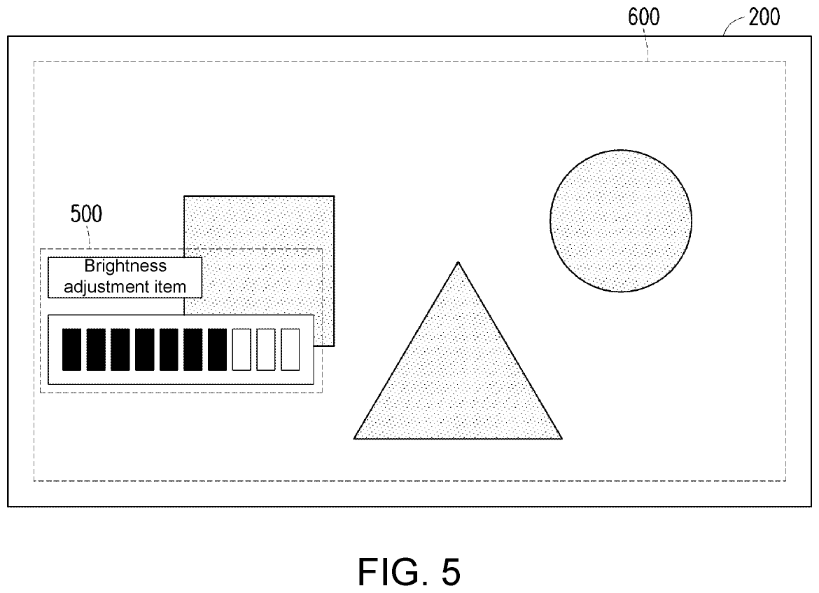

On the other hand, FIG. 5 is a schematic view of the screen displaying a second menu according to an embodiment of the disclosure. Referring to FIG. 5, the projector 100 is in the image display mode in which an image 600 projected by the projector 100 is displayed on the screen 200 (no image overlapping with the image 600 on the screen 200). At this time, when the shuttle wheel 120 is turned, the controller circuit 110 may control the projector 100 not to enter the on screen display mode but, instead, to directly display a second menu 500 overlapping with the image 600 on the screen 200. In other words, the projector 100 does not enter the on screen display mode, and the controller circuit 110 controls the projector to project the second menu 500 (a default adjustment item) on the screen 200 for the user (and/or the controller circuit 110) to set an adjustment value of the adjustment item of the projector 100 on the second menu 500. In the embodiment, the size of the first menu 400 displayed on the screen 200 is larger than the size of the second menu 500 displayed on the screen 200.

In an embodiment, the projector 100 is not in the image display mode. That is, the image 600 is not displayed on the screen 200. At this time, when the shuttle wheel 120 is turned (the projector 100 does not enter the on screen display mode), the controller circuit 110 may control the projector 100 to enter the image display mode to project the image 600 and the second menu 500 on the screen 200. The second menu 500 overlaps with the image 600. In this case, the image 600 may be, for example, a blank image, an icon image, or other default images.

In the embodiment, the adjustment items of the projector 100 on the second menu 500 may be set in advance in the on screen display mode (for example, the first menu 400). That is, the user may define the adjustment items displayed on the second menu 500 by himself. More specifically, the adjustment items of the projector 100 displayed on the second menu 500 may be set via the menu setting adjustment item on the first menu 400. For example, in the menu setting adjustment item, the adjustment items (i.e., the picture mode selection adjustment item, the gamma selection adjustment item, the volume adjustment item, the brightness adjustment item, and the input source selection adjustment item) may be sequentially and cyclically provided. Accordingly, the user may select the adjustment items of the projector 100 on the second menu 500 by turning the shuttle wheel 120. For example, the brightness adjustment item is initially displayed on the menu setting adjustment item, and the user may turn the shuttle wheel 120 to the right to sequentially select the input source selection adjustment item, the picture mode selection adjustment item, the gamma selection adjustment item, and the volume adjustment item, and then return to the brightness adjustment item. Also, the user may turn the shuttle wheel 120 to the left to sequentially select the volume adjustment item, the gamma selection adjustment item, the picture mode selection adjustment item, and the input source selection adjustment item, and then return to the brightness adjustment item.

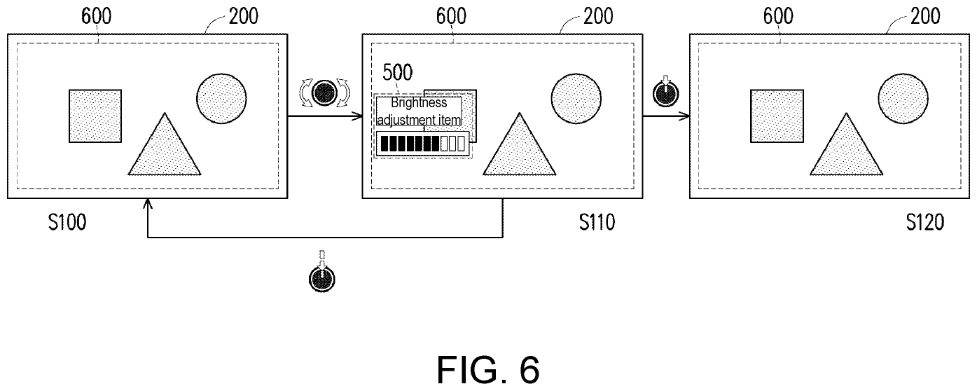

FIG. 6 is a flow chart of the screen displaying the second menu according to an embodiment of the disclosure. Referring to FIG. 1 and FIG. 6, in step S100, the projector 100 is in the image display mode and projects the image 600 on the screen 200, and the screen 200 displays the image 600. When the shuttle wheel 120 is turned, the display process proceeds to step S110 from step S100. In step S110, the controller circuit 110 controls the projector 100 not to enter the on screen display mode but, instead, to display the second menu 500 overlapping with the image 600 on the screen 200. In step S110, for example, the brightness adjustment item is set as the adjustment item on the second menu 500. When the second menu 500 is displayed and the shuttle wheel 120 is turned, the controller circuit 110 may adjust the brightness (the adjustment value of the adjustment item) of the image 600. It is understandable that in the case where the second menu 500 is set to other adjustment items, when the second menu 500 is displayed, the shuttle wheel 120 may be turned so as to adjust other adjustment items, such as the volume, gamma selection, or input source selection. In addition, in step S110, a preview function may be further included. That is, when the second menu 500 is displayed and the shuttle wheel 120 is turned, the brightness of the image 600 (or other corresponding adjustment items) may be adjusted instantly.

Further, in step S110, when the shuttle wheel 120 is pressed, the display process proceeds to step S120 from step S110. In step S120, the projector 100 is in the image display mode, and the brightness of the image 600 is displayed according to a brightness adjustment result in step S110, which means a brightness setting is completed and the brightness setting is saved. On the other hand, in step S110, when the shuttle wheel 120 is long pressed, the display process returns to step S100 from step S110, which means that the controller circuit 110 controls the projector 100 to exit the second menu 500 and return to the image display mode. The brightness of the image 600 is not changed. That is, the brightness setting just set is not saved.

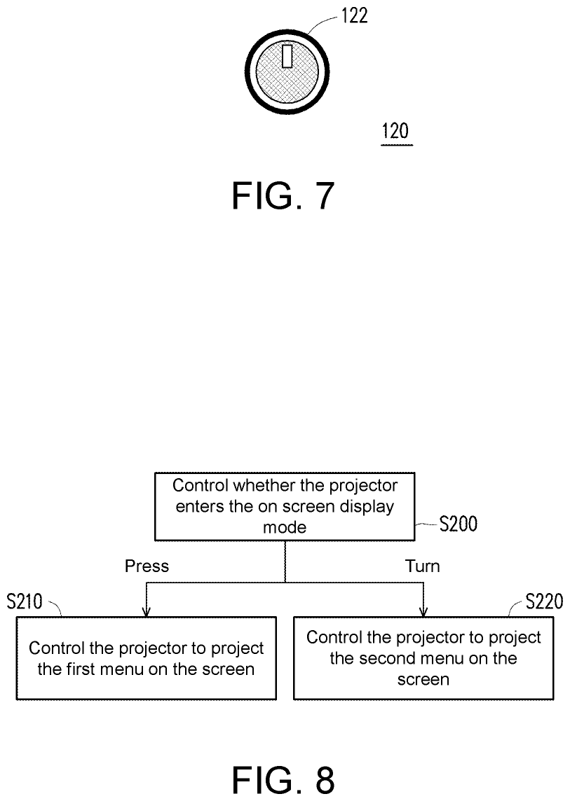

FIG. 7 is a schematic view of the shuttle wheel according to an embodiment of the disclosure. Referring to FIG. 7, in the embodiment, the shuttle wheel 120 includes an indicator light bar 122 configured to show a current adjustment item setting of the projector 100. For example, the indicator light bar 122 may show a setting of the adjustment item of the projector 100 with different colors. Also, the indicator light bar 122 may show the setting of the adjustment item of the projector 100 with different colors in combination with different ways of display, for example, blinking, fading up, fading away, and pulsing. In another embodiment, the indicator light bar 122 may show the setting of the adjustment item of the projector 100 and the status of the projector 100 (for example, startup, operation, sleep and adjusting) with different colors in combination with different ways of display.

FIG. 8 is a procedure flow chart of a method for operating the projector according to an embodiment of the disclosure. Referring to FIG. 1, FIG. 2, and FIG. 8, the projector operation method in the embodiment is at least adapted for the projector 100 in FIG. 1 and FIG. 2; however, the disclosure is not limited thereto. Taking the projector 100 in FIG. 1 and FIG. 2 as an example, in step S200, the controller circuit 110 controls whether the projector 100 enters the on screen display mode according to the operation method of the shuttle wheel 120. When the shuttle wheel 120 is pressed, the projector 100 enters the on screen display mode and step S210 of the operation method is performed. When the shuttle wheel 120 is turned, the projector 100 does not enter the on screen display mode and step S220 of the operation method is performed. In step S210, the controller circuit 110 controls the projector 100 to project the first menu 400 on the screen 200. In step S220, the controller circuit 110 controls the projector 100 to project the second menu 500 on the screen 200. In addition, sufficient teaching, suggestion, and implementation of the method for operating the projector 100 in the embodiment may be acquired from the descriptions of the embodiment in FIG. 1 to FIG. 7.

In light of the above, the embodiment of the disclosure at least includes one of the following advantages or features. A shuttle wheel is designed on an upper cover of a projector so that a user can directly adjust a picture mode selection adjustment item, a gamma selection adjustment item, a volume adjustment item, a brightness adjustment item, an input source selection adjustment item, a menu setting adjustment item and a general setting adjustment item, allowing the user to operate conveniently and intuitively. The user can look at the displayed image and turn the shuttle wheel for setting. In addition, to meet a demand of each user, a shortcut function (the second menu) can be defined by the user.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projector, comprising a controller circuit and a shuttle wheel, wherein
the controller circuit is configured to control an operation of the projector; and
the shuttle wheel is disposed on an upper cover of the projector and is coupled to the controller circuit, wherein the controller circuit controls whether the projector enters an on screen display mode according to an operation method of the shuttle wheel,
the controller circuit controls the projector to project a first menu on a screen when the projector enters the on screen display mode, and the controller circuit sets an adjustment item of the projector on the first menu according to the operation method of the shuttle wheel; and
the controller circuit controls the projector to project a second menu on the screen when the projector does not enter the on screen display mode, and the controller circuit sets an adjustment value of the adjustment item of the projector on the second menu according to the operation method of the shuttle wheel.

2. The projector according to claim 1, wherein the operation method of the shuttle wheel comprises pressing the shuttle wheel and turning the shuttle wheel, the controller circuit controls the projector to enter the on screen display mode when the shuttle wheel is pressed, and the controller circuit controls the projector not to enter the on screen display mode when the shuttle wheel is turned.

3. The projector according to claim 1, wherein the first menu and the second menu comprise the adjustment item of the projector, and the adjustment item of the projector on the second menu is set in advance in the on screen display mode.

4. The projector according to claim 1, wherein the controller circuit controls the projector to enter an image display mode to project an image on the screen when the projector does not enter the on screen display mode, and the second menu overlaps with the image.

5. The projector according to claim 1, wherein a size of the first menu displayed on the screen is larger than a size of the second menu displayed on the screen.

6. The projector according to claim 1, wherein the shuttle wheel comprises an indicator light bar configured to show a setting of the adjustment item of the projector.

7. The projector according to claim 1, wherein the adjustment item of the projector is one of a picture mode selection adjustment item, a gamma selection adjustment item, a volume adjustment item, a brightness adjustment item, and an input source selection adjustment item.

8. A method for operating a projector, wherein the projector comprises a shuttle wheel, the method for operating the projector comprises:
controlling whether the projector enters an on screen display mode according to an operation method of the shuttle wheel;
controlling the projector to project a first menu on a screen when the projector enters the on screen display mode, and setting an adjustment item of the projector on the first menu according to the operation method of the shuttle wheel; and
controlling the projector to project a second menu on the screen when the projector does not enter the on screen display mode, and setting an adjustment value of the adjustment item of the projector on the second menu according to the operation method of the shuttle wheel.

9. The method for operating the projector according to claim 8, wherein the operation method of the shuttle wheel comprises pressing the shuttle wheel and turning the shuttle wheel, and controlling the projector whether to enter the on screen display mode according to the operation method of the shuttle wheel comprises:
controlling the projector to enter the on screen display mode when the shuttle wheel is pressed; and
controlling the projector not to enter the on screen display mode when the shuttle wheel is turned.

10. The method for operating the projector according to claim 8, further comprising:
setting the adjustment item of the projector on the second menu in advance in the on screen display mode.

11. The method for operating the projector according to claim 8, wherein, when the projector does not enter the on screen display mode, the method for operating the projector further comprises:
controlling the projector to enter an image display mode to display an image on the screen, wherein the second menu overlaps with the image.

12. The method for operating the projector according to claim 8, wherein a size of the first menu displayed on the screen is larger than a size of the second menu displayed on the screen.

13. The method for operating the projector according to claim 8, wherein the shuttle wheel comprises an indicator light bar configured to show a setting of the adjustment item of the projector.

14. The method for operating the projector according to claim 8, wherein the adjustment item of the projector is one of a picture mode selection adjustment item, a gamma selection adjustment item, a volume adjustment item, a brightness adjustment item, and an input source selection adjustment item.
